(19) United States
(12) Patent Application Publication
(10) Pub. No.: US 2016/0199163 A1
(43) Pub. Date: Jul. 14, 2016

(54) SYSTEM FOR DISPENSING AND DISCARDING MATERIAL

(71) Applicant: Michael Kabrin, Granada Hills, CA (US)

(72) Inventor: Michael Kabrin, Granada Hills, CA (US)

(21) Appl. No.: 14/708,123

(22) Filed: May 8, 2015

Related U.S. Application Data
(60) Provisional application No. 62/125,049, filed on Jan. 12, 2015.

(51) Int. Cl. A61C 15/04

(52) U.S. Cl. CPC A61C 15/043; A61C 15/046

(57) ABSTRACT

A system for dispensing and discarding material, the system comprising a supply reel housing, an out-feed opening in the supply reel housing, a take-up reel housing, an in-feed opening in the take-up reel housing, a take-up reel removably and rotatably mounted within the take-up reel housing, a first locking mechanism to prevent movement of the take-up reel, and a first wind-up means on the take-up reel for winding a dispensed length of material on the take-up reel, wherein the supply reel housing and the take-up reel housing are removably coupled to each other and when coupled together, the supply reel housing covers the in-feed opening and the take-up reel housing covers the out-feed opening.

### BACKGROUND

Professionals in the dental field have long extolled the benefits of regularly flossing one's teeth. Those benefits include prevention of plaque build-up, periodontal and other tooth and gum related diseases and reducing the number of bacteria between teeth to prevent decay and unpleasant smelling breath.

Typically, a dental floss dispenser consists of a single container containing a roll of unused dental floss. When a user is ready to floss their teeth, they extract a desired length of floss from the case and then cut the floss to completely separate it from the case. The user then wraps each end of the length of floss around a fingertip from each hand and draws the length of floss tight. The user proceeds to insert the floss into their mouth and their fingers work to force the floss into the spaces between the teeth. This procedure is typically repeated for each space between all of the user's teeth.

When in use, the actual length of dental floss needed to perform the flossing procedure is minimal, typically only a couple inches or so depending upon the user. However, due to the fact that a user must wrap the ends of the dental floss around their fingertips in order to maintain adequate tension on the floss, a longer length of dental floss is needed. Thus, a problem associated with using floss dispensed from a typical dental floss dispenser is that a user will use much more dental floss than is necessary to perform the flossing procedure, and will consequently consume a spool of dental floss much more quickly. This results in more expense to the user, which is not desirable.

Once the act of flossing is completed, the user must then unwind the dental floss from their fingertips. Circulation in the finger tips is almost always hindered in some way due to wrapped dental floss, and this can be very uncomfortable for a user. Moreover, used dental floss has a tendency to stick to a user's fingers, and in an attempt to get the used dental floss off their fingertips and into the trash, the used dental floss typically ends up on the floor or in the toilet instead. As a consequence, many cities are suffering from sewer back-ups that are caused in part by dental floss being flushed down the toilets and tangling in the sewer lines.

If the dental floss does make it into the trash it usually ends up in a landfill. Typically, dental floss is not biodegradable and remains in the soil for an extended period of time, damaging the environment. Even more concerning is the fact that animals often visit landfills looking for food, and will consume the used dental floss due to its appetizing flavor and scent. Once consumed, the dental floss can wrap itself around the digestive tract of the animal, typically leading to death of the animal.

Household pets and domesticated animals are not free from this danger either, due to the fact that the used dental floss typically will find its way to the bathroom floor instead of making it into the trash can. Additionally, mischievous animals can easily get into trash cans and swallow the used dental floss. Thus, not only will the users have to deal with excessive veterinary bills, but if undiagnosed, the pet can die.

Along the same lines, dental sticks and floss-dental sticks are used by many people to floss their teeth. These are typically one-time use and result in an even larger amount of waste due to the additional plastic/wood structure. Moreover, if animals swallow the dental sticks the resulting harm is usually death. Additionally, if the dental sticks are flushed down the toilet, serious sewer problems can result.

Accordingly, there is a need for a system for dispensing and discarding material that addresses the problems often encountered with the use of typical dental floss dispensers.

### SUMMARY OF THE INVENTION

The present invention satisfies this need. The present invention is a unique system for dispensing and discarding material. According to one embodiment of the present invention, there is provided a system for dispensing and discarding material, the system comprising a supply reel housing, wherein the supply reel housing comprises an upper portion and a lower portion, one or more supply reel supports located in the supply reel housing, a supply reel comprising a supply of material, the supply reel removably and rotatably coupled to the one or more supply reel supports, an out-feed opening in the supply reel housing, a take-up reel housing, wherein the take-up reel housing comprises an upper portion and a lower portion, one or more take-up reel supports located in the take-up reel housing, a take-up reel removably and rotatably coupled to the one or more take-up reel supports, a slot located on the take-up reel that is configured to retain the supply of material, an in-feed opening in the take-up reel housing, a first locking mechanism to prevent movement of the take-up reel, and a first wind-up means on the take-up reel for winding a dispensed length of material on the take-up reel, wherein the supply reel housing and the take-up reel housing are removably coupled to each other and wherein when coupled together, the supply reel housing covers the in-feed opening and the take-up reel housing covers the out-feed opening.

Optionally, the first wind-up means can comprise manual wind-up means. Additionally, the supply of material comprises dental floss. Optionally, the upper portion and the lower portion of the supply reel housing can be coupled together by one or more living hinges, and the upper portion and the lower portion of the take-up reel housing can be coupled together by one or more living hinges.

In another embodiment of the present invention, the system for dispensing and discarding material comprises a supply reel housing, an out-feed opening in the supply reel housing, a take-up reel housing, an in-feed opening in the take-up reel housing, a take-up reel removably and rotatably mounted within the take-up reel housing, a first locking mechanism to prevent movement of the take-up reel, and a first wind-up means on the take-up reel for winding a dispensed length of material on the take-up reel, wherein the supply reel housing and the take-up reel housing are removably coupled to each other and when coupled together, the supply reel housing covers the in-feed opening and the take-up reel housing covers the out-feed opening. The supply reel housing can comprise an upper portion and a lower portion, and the upper portion of the supply reel housing can be coupled to the lower portion of the supply reel housing by a living hinge.

Additionally, the take-up reel housing can comprise an upper portion and a lower portion, and the upper portion of the take-up reel housing can be coupled to the lower portion of the take-up reel housing by a living hinge.

Optionally, the system can further comprise a supply reel removably and rotatably mounted within the supply reel housing. Additionally, the system can further comprise one or more supply reel supports located within the supply reel housing and the supply reel can be removably and rotatably coupled to the one or more supply reel supports. Moreover, the system can further comprise a supply of material coupled to the supply reel, and the supply of material can comprise dental floss.

Optionally, the system can further comprise a second locking mechanism to prevent movement of the supply reel.

Additionally, the supply reel housing can comprise at least one male connector and the take-up reel housing comprises at least one female connector, wherein the at least one male connector is coupled to the at least one female connector.

In another embodiment of the present invention, there is provided a method of using the system for dispensing and discarding material to avoid the problems typically caused by use of traditional dental floss dispensers, wherein the method comprises the steps of separating the upper portion of the supply reel housing from the lower portion of the supply reel housing, separating the upper portion of the take-up reel housing from the lower portion of the take-up reel housing, placing the supply reel into the supply reel housing, placing the take-up reel into the take-up reel housing, dispensing the supply of material out of the supply reel housing through the out-feed opening and into the take-up reel housing through the in-feed opening, inserting the supply of material into the slot located on the take-up reel, winding the take-up reel using the first wind-up means to secure the supply of material to the take-up reel, coupling the upper portion of the supply reel housing to the lower portion of the supply reel housing, coupling the upper portion of the take-up reel housing to the lower portion of the take-up reel housing, and flossing a user's teeth with the dispensed supply of material. Additionally, the supply of material can comprise dental floss.

### DRAWINGS

These and other features, aspects and advantages of the present invention will become better understood with reference to the following description, appended claims, and accompanying drawings where:

FIG. 1 is a perspective view of system for dispensing and discarding material having features of the present invention;

FIG. 2 is a perspective view of the system according to FIG. 1, wherein the supply reel housing and take-up reel housing are uncoupled;

FIG. 3 is an exploded perspective view of the system according to FIG. 1, wherein a supply reel containing a supply of material has been installed;

FIG. 4 is an exploded view of the system according to FIG. 1;

FIG. 5 is a bottom plan exploded view of a take-up reel housing according to the present invention;

FIG. 6A is a perspective view of a take-up reel housing according to the present invention, wherein the upper portion and lower portion are coupled together by a living hinge; and

FIG. 6B is a perspective view of a supply reel housing according to the present invention, wherein the upper portion and lower portion are coupled together by a living hinge.

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

### DEFINITIONS

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers, ingredients or steps.

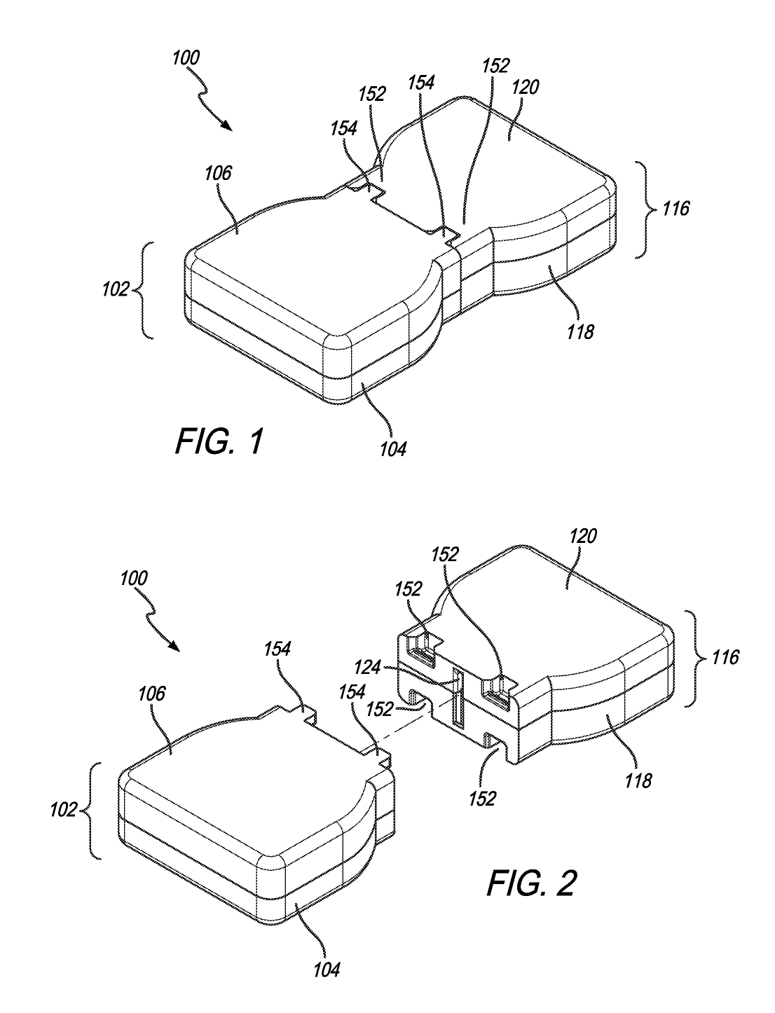

Referring now to FIGS. 1 and 2, a system for dispensing and discarding material having features of the present invention is shown. The system for dispensing and discarding material 100 comprises a supply reel housing 102, an out-feed opening 110 in the supply reel housing 102, a take-up reel housing 116, an in-feed opening 124 in the take-up reel housing 116, a take-up reel 126 removably and rotatably mounted within the take-up reel housing 116, a first locking mechanism 142 to prevent movement of the take-up reel 126, and a first wind-up means 148 on the take-up reel 126 for winding a dispensed length of material 162 on the take-up reel 126, wherein the supply reel housing 102 and the take-up reel housing 116 are removably coupled to each other. When coupled together, the supply reel housing 102 covers the in-feed opening 124 and the take-up reel housing 116 covers the out-feed opening 110, as shown in FIG. 1.

Preferably, the supply reel housing 102 and the take-up reel housing 116 are removably coupled to each other, as shown in FIG. 2. When the supply reel housing 102 and the take-up reel housing 116 are coupled together, the supply reel housing 102 covers the in-feed opening 124 and the take-up reel housing 116 covers the out-feed opening 110. This is advantageous because it allows the unused dental material 160 to remain covered and prevents contamination from outside sources. Additionally, when coupled together, the supply reel housing 102 and the take-up reel housing 116 form a compact unit which allows the user to easily carry and store the system for dispensing and discarding material 100. Moreover, when the supply reel housing 102 and the take-up reel housing 116 are coupled together, the user is less likely to misplace one housing or other.

The supply reel housing 102 and the take-up reel housing 116 can be removably coupled together by any mechanical coupling means, including but not limited to, a snapping mechanism, a suction mechanism, a screw mechanism, a magnetic mechanism and a rotating locking mechanism. Preferably, the supply reel housing 102 and the take-up reel housing 116 are removably coupled together by one or more sets of connectors, each set of connectors comprising a female connector 152 and a male connector 154, as shown in FIGS. 1-4. The one or more sets of connectors are located on the same side of the supply reel housing 102 and the take-up reel housing 116 as the out-feed opening 110 and in-feed opening 124. The male connector 154 comprises a projection which is connected to and extends away from the supply reel housing 102 at a first location. The corresponding female connector 152 comprises a recess located at the same location on the take-up reel housing 116. Thus, the male connector 154 can be inserted into the corresponding female connector 152, removably coupling the supply reel housing 102 to the take-up reel housing 116. Optionally, the male connector 154 can be located on the take-up reel housing 116 and the female connector 152 can be located on the supply reel housing 102. Moreover, the one or more sets of connectors can be located on either the upper portion 106 or lower portion 104 of the supply reel housing 102 or the upper portion 120 or the lower portion 118 of the take-up reel housing 116.

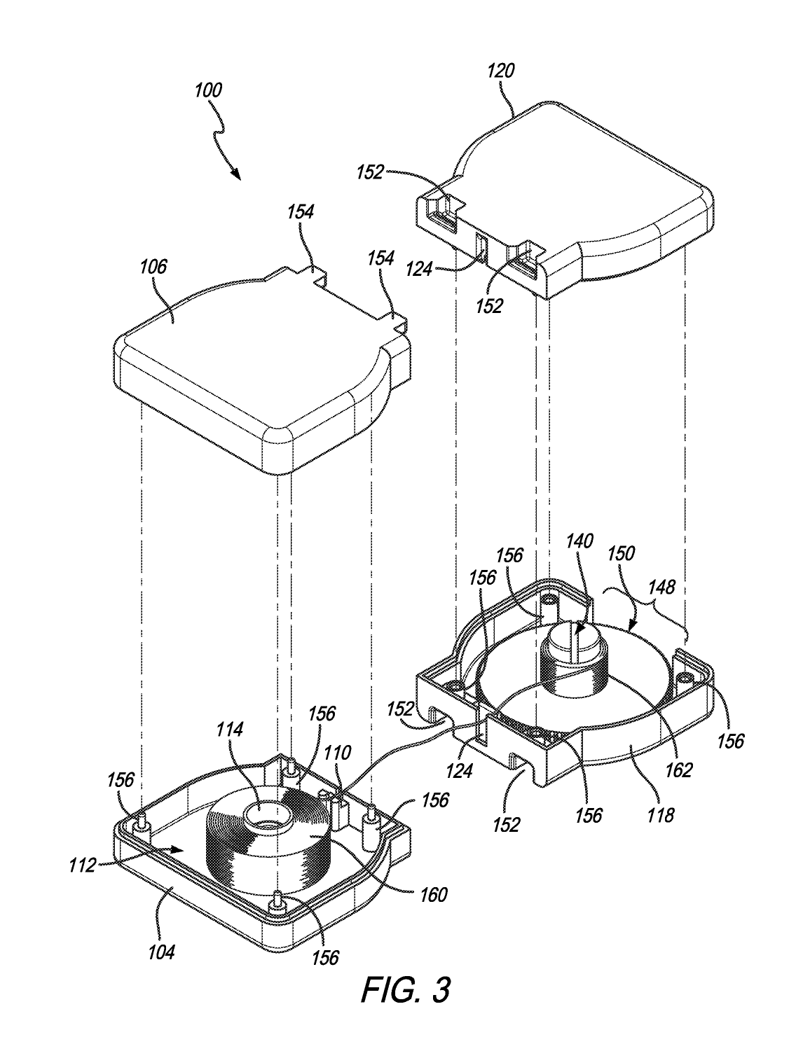

Referring now to FIG. 3, the supply reel housing 102 houses and dispenses a supply of unused material 160 which is wrapped around a supply reel 112. The supply reel 112 is removably and rotatably mounted within the supply reel housing 102. Optionally, the supply reel housing 102 can comprise one or more supply reel supports 108 and the supply reel 112 can comprise an opening 114 at the center of the supply reel 112. The opening 114 at the center of the supply reel 112 can be placed over and around the one or more supply reel supports 108, allowing the supply reel 112 to freely rotate. The supply reel housing 102 also comprises an out-feed opening 110, which provides a pathway for the supply of unused material 160 to exit the supply reel housing 102. The supply of unused material 160 wrapped around the supply reel 112 and dispensed from the supply reel housing 102 can be any material, but preferably the material comprises unused dental floss or dental tape. For the ease of discussion, dental floss and dental tape will be referred to collectively as dental material for the remainder of this application.

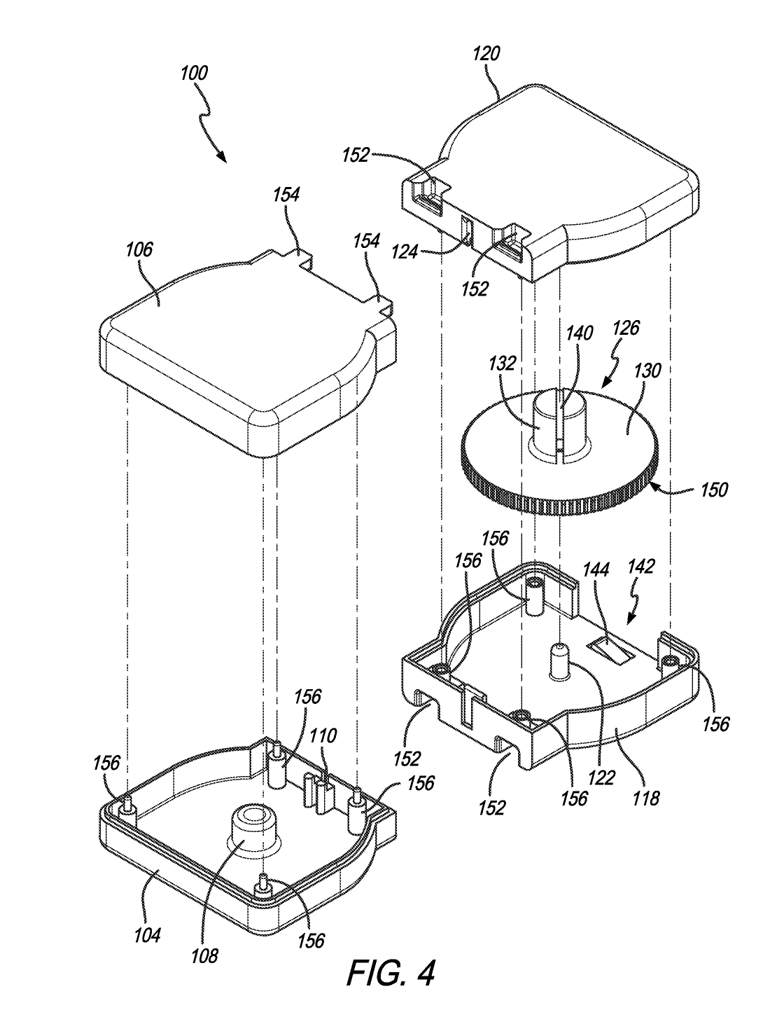

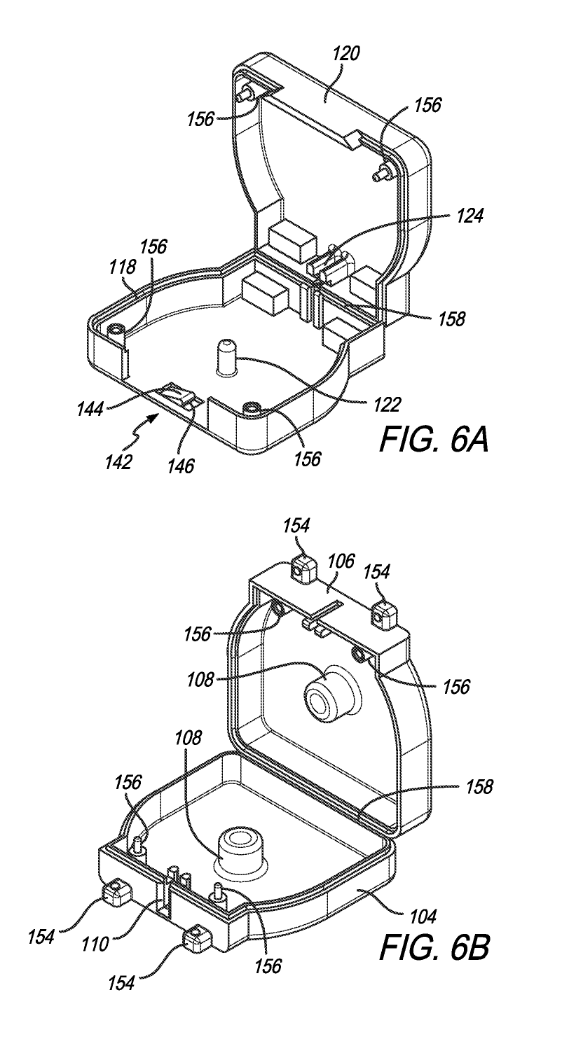

The supply reel housing 102 can be any shape, including but not limited to a triangle, a rectangle, a square, a circle, and an oval. The supply reel housing 102 can be any dimension, but preferably is approximately 1 inch to 4 inches long, approximately 1 inch to 4 inches wide, and approximately 0.5 inches to 4 inches tall. Preferably, the supply reel housing 102 is 1 inch and 3 millimeters long, 1 inch and 5 millimeters wide, and 7 millimeters tall. Additionally, the supply reel housing 102 can comprise a lower portion 104 and an upper portion 106, which can be removably coupled together, as shown in FIGS. 3 and 4. The lower portion 104 and the upper portion 106 can be removably coupled together by any coupling means 156, including but not limited to a set of male and female connectors, dowels, screws, bolts, snapping mechanisms and living hinges 158. Living hinges 158 are also known as integrated hinges. Preferably, the upper portion 106 and the lower portion 104 are coupled together by one or more living hinges 158, as shown in FIG. 6B. When a user desires to access the interior of the supply reel housing 102, in order to replace or insert a new supply reel 112, the user can simply remove the upper portion 106 from the lower portion 104, providing access, as shown in FIGS. 3 and 4.

The supply reel housing 102 can be made from any material, including but not limited to plastic, metal, fiberglass, carbon fiber, wood or biodegradable material. Preferably, the supply reel housing 102 is made from a plastic material. Additionally, either the upper portion 106 or the lower portion 104 or both can be made from a transparent material to allow the user to view the interior and determine when the supply reel 112 has dispensed all of its supply of unused dental material 160.

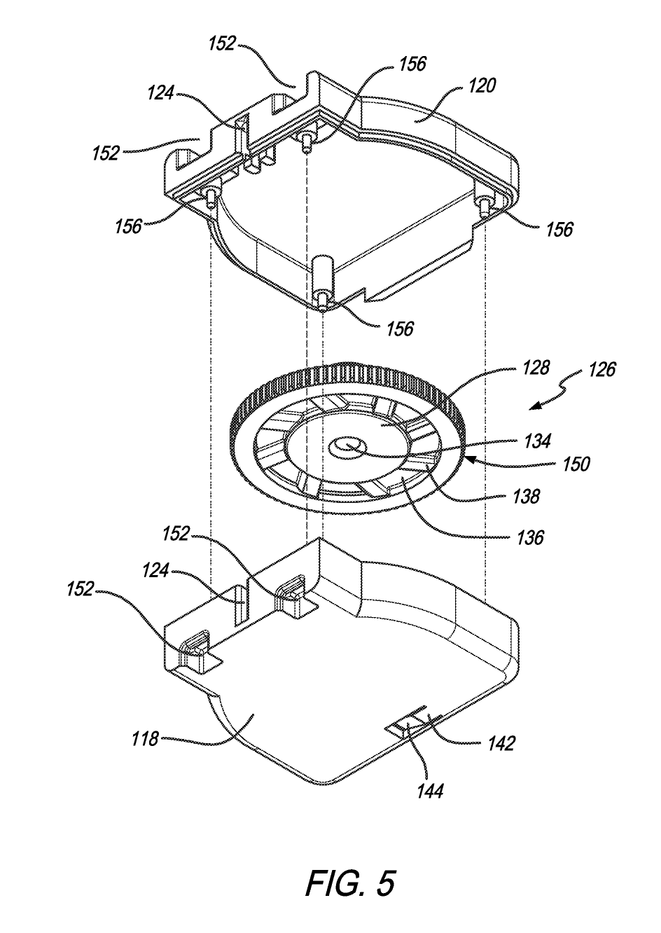

As shown in FIG. 3, the take-up reel housing 116 houses and receives a length of material 162, preferably used dental material, to be wound around a take-up reel 126. The take-up reel 126 is removably and rotatably mounted within the take-up reel housing 116. Additionally, the take-up reel 126 can have a lower surface 128 and an upper surface 130 and can optionally comprise a hollow shaft 132 extending vertically away from and perpendicular to the upper surface 130 of the take-up reel 126. As shown in FIG. 5, the hollow shaft 132 can have an opening 134 in the lower surface 128 of the take-up reel 126. Moreover, the take-up reel housing 116 can comprise one or more take-up reel supports 122 and the hollow shaft 132 of the take-up reel 126 can be placed over and around the one or more take-up reel supports 122, allowing the take-up reel 126 to rotate. Additionally, the take-up reel housing 116 also comprises an in-feed opening 124 which provides a pathway for the used dental material 162 to enter the take-up reel housing 116.

The take-up reel housing 116 can be any shape, including but not limited to a triangle, a rectangle, a square, a circle, and an oval. The take-up reel housing 116 can be any dimension, but preferably is about 1 inch to 4 inches long, approximately 1 inch to 4 inches wide, and approximately 0.5 inches to 4 inches tall. Preferably, the take-up reel housing 116 is 1 inch and 3 millimeters long, 1 inch and 5 millimeters wide, and 7 millimeters tall. Additionally, the take-up reel housing 116 can comprise a lower portion 118 and an upper portion 120, which can be removably coupled together, as shown in FIGS. 3 and 4. The lower portion 118 and the upper portion 120 can be removably coupled together by any coupling means 156, including but not limited to a set of male and female connectors, dowels, screws, bolts, and snapping mechanisms. Preferably, the upper portion 120 and the lower portion 118 are coupled together by one or more living hinges 158, as shown in FIG. 6A. When a user desires to access the interior of the take-up reel housing 116, in order to remove the used dental material 162 from the take-up reel 126, the user can simply remove the upper portion 120 from the lower portion 118, providing access.

The take-up reel housing 116 can be made from any material, including but not limited to plastic, metal, fiberglass, carbon fiber, wood or biodegradable material. Preferably, the take-up reel housing 116 is made from a plastic material. Additionally, either the upper portion 120 or the lower portion 118 or both can be made from a transparent material to allow the user to view the interior and determine when the take-up reel 126 has reached its capacity to hold the used dental material 162.

Additionally, it would be undesirable to have used dental material 162 dispensed out of the take-up reel housing 116, as a user may be unable to tell the difference between the used dental material 162 and unused dental material 160, and may inadvertently re-use used dental material 162. Thus, in order to prevent dispensing of used dental material 162, a first locking mechanism 142 is provided, as shown in FIGS. 4 and 5. The first locking mechanism 142 can comprise any form of locking mechanism, but in one embodiment of the present invention, the first locking mechanism 142 can comprise a resilient cantilever spring 144 of one piece of the take-up reel housing 116 and a catch 146 at the free end of the resilient cantilever spring 144. Additionally, the lower surface 128 of the take-up reel 126 can comprise an engaging mechanism for the first locking mechanism 142 to engage. Optionally, the engaging mechanism on the take-up reel 126 can comprise one or more projections (not shown) or one or more recessed sections 136, creating one or more ridges 138, located on the lower surface 128 of the take-up reel 126. The resilient cantilever spring 144 normally biases the catch 146, due to its inherent resilience, into ratcheting engagement with the recessed sections 136 and the ridges 138 located on the lower surface 128 of the take-up reel 126. In this way, the take-up reel 126 may only rotate in one direction to take up used dental material 162. It is prevented from rotating in the other direction and dispensing used material 162.

Optionally, the supply reel housing 102 can comprise a second locking mechanism (not shown) which prevents dispensing of the supply of unused material 160 when it is not desired by the user. The second locking mechanism allows the user to maintain tension on the dispensed supply of unused material 160 that extends between the supply reel housing 102 and the take-up reel housing 116. The second locking mechanism can comprise any form of locking mechanism, but it is envisioned that the second locking mechanism can comprise a second resilient cantilever spring of one piece of the supply reel housing 102 and a catch at the free end of the resilient cantilever spring. Additionally, the supply reel 112 could comprise an engaging mechanism (not shown) to engage the second locking mechanism, allowing the second locking mechanism to prevent the supply reel 112 from rotating. The engaging mechanism on the supply reel 112 could comprise any form of engaging mechanism, which could comprise one or more projections or one or more recessed sections and ridges for the second locking mechanism to engage.

As shown in FIGS. 3 and 4, the first wind-up means 148 can comprise any means capable of winding up the used dental material 162 onto the take-up reel 126, including manual means or automatic means. In one embodiment, the first wind-up means 126 comprises a grip 150 on the take-up reel 126, which allows the user to manually turn the take-up reel 126 in one direction to cause the used dental material 162 to be taken into the take-up reel housing 116 and wound around the take-up reel 126.

Optionally, the first wind-up means 148 can comprise an automatic wind-up means (not shown) to wind up the used dental material 162. The automatic wind-up means can be powered by a power source (not shown), and the power source can be any power source, including but not limited to, photocells, solar power, kinetic energy, a recoil mechanism, or a battery. The battery can be any size or shape, and can be a reusable battery or a replaceable battery. Optionally the power source can be an external power source.

In one embodiment the automatic wind-up means can comprise a motor (not shown) coupled to both the take-up reel 126 and the power source. The automatic wind-up means can further comprise a power switch or power button, which activates the power source to supply power to the motor, which in turn causes the motor to rotate the take-up reel 126, thereby automatically wind up the used dental material 162 on the take-up reel 126.

Additionally, a second wind-up means (not shown) can also be located on the supply reel housing 102, permitting the user to retract any dispensed but unused supply of material 160, re-winding the unused supply of material 160 onto the supply reel 112. In the event that the user dispenses more material than is needed, the user can retract the unused supply of material 160 and save it for later use, thereby reducing waste. The second wind-up means can comprise any means capable of re-winding the unused dental material 160 back onto the supply up reel 112, including manual means or automatic means. In one embodiment, the second wind-up means can comprise a grip on the supply up reel 112, which allows the user to manually turn the supply reel 112 in one direction to cause the unused dental material 160 to be taken back into the supply reel housing 102 and re-wound around the supply reel 112.

Optionally, the second wind-up means can comprise an automatic wind-up means to re-wind the unused dental material 160. The automatic wind-up means can be powered by a power source and the power source can be any power source, including but not limited to, photocells, solar power, kinetic energy, a recoil mechanism, or a battery. The battery can be any size or shape, and can be a reusable battery or a replaceable battery. Optionally the power source can be an external power source.

As shown in FIGS. 3-6, the lower portion 104 and the upper portion 106 of the supply reel housing 102 and the lower portion 118 and the upper portion 120 of the take-up reel housing 116 can be removably coupled together by a coupling means 156. The coupling means 156 can comprise any mechanical coupling means, including but not limited to, a snapping mechanism, a suction mechanism, a screw mechanism, a magnetic mechanism, and a rotating locking mechanism. In one embodiment, the coupling means 156 comprises one or more sets of male and female connectors.

Optionally, as shown in FIGS. 6A and 6B the upper portions 106, 120 and the lower portions 104, 118 can be coupled together by any combination of coupling means 156 and one or more living hinges 158. It should be appreciated that the one or more living hinges 158 can be located along any of the edges of the supply reel housing 102 and the take-up reel housing 116. Preferably, the one or more living hinges 158 located on the supply reel housing 102 couple the lower portion 104 and the upper portion 106 together along the bottom edge of the supply reel housing 102, as shown in FIG. 6B, and the one or more living hinges 158 located on the take-up reel housing 116 couple the lower portion 118 and the upper portion 120 together along the top edge of the take-up reel housing 116, as shown in FIG. 6A. Additionally, the upper portions 106, 120 and the lower portions 104, 118 can be coupled together by any combination of coupling means 156 and living hinges 158.

As shown in FIG. 3, a method of using the system for dispensing and discarding material 100 comprises the steps of separating the upper portion 106 of the supply reel housing 102 from the lower portion 104 of the supply reel housing 102, separating the upper portion 120 of the take-up reel housing 116 from the lower portion 118 of the take-up reel housing 116, placing the supply reel 112 into the supply reel housing 102, placing the take-up reel 126 into the take-up reel housing 116, dispensing the supply of unused material 160 out of the supply reel housing 102 through the out-feed opening 110 and into the take-up reel housing 116 through the in-feed opening 124, inserting the supply of unused material 160 into the slot 140 located on the take-up reel 126, winding the take-up reel 126 using the first wind-up means 148 to secure the supply of unused material 160 to the take-up reel 126, coupling the upper portion 106 of the supply reel housing 102 to the lower portion 104 of the supply reel housing 102, coupling the upper portion 120 of the take-up reel housing 116 to the lower portion 118 of the take-up reel housing 116, and flossing a user's teeth with the dispensed supply of material 160.

Additionally, the supply reel housing 102 and the take-up reel housing 116 can be disposable. If the user desires to reuse the supply reel housing 102 and the take-up reel housing 116, the used supply of material 162 can be housed in a separate disposable container (not shown), wherein the container may comprise a disposable pouch. Once the used supply of material 162 has been removed from the take-up reel housing 116, the user can then clean either or both the supply reel housing 102 and the take-up reel housing 116, and insert a new supply of unused material 160.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A system for dispensing and discarding material, the system comprising:
a. a supply reel housing, wherein the supply reel housing comprises an upper portion and a lower portion;
b. one or more supply reel supports located in the supply reel housing;
c. a supply reel comprising a supply of material, the supply reel removably and rotatably coupled to the one or more supply reel supports;
d. an out-feed opening in the supply reel housing;
e. a take-up reel housing, wherein the take-up reel housing comprises an upper portion and a lower portion;
f. one or more take-up reel supports located in the take-up reel housing;
g. a take-up reel removably and rotatably coupled to the one or more take-up reel supports;
h. a slot located on the take-up reel that is configured to retain the supply of material;
i. an in-feed opening in the take-up reel housing;
j. a first locking mechanism to prevent movement of the take-up reel; and
k. a first wind-up means on the take-up reel for winding a dispensed length of material on the take-up reel;
wherein the supply reel housing and the take-up reel housing are removably coupled to each other and wherein when coupled together, the supply reel housing covers the in-feed opening and the take-up reel housing covers the out-feed opening.

2. The system according to claim 1, wherein the first wind-up means comprises manual wind-up means.

3. The system according to claim 1, wherein the supply of material comprises dental floss.

4. The system according to claim 1, wherein the upper portion and the lower portion of the supply reel housing are coupled together by one or more living hinges.

5. The system according to claim 1, wherein the upper portion and the lower portion of the take-up reel housing are coupled together by one or more living hinges.

6. A system for dispensing and discarding material, the system comprising:
a. a supply reel housing;
b. an out-feed opening in the supply reel housing;
c. a take-up reel housing;
d. an in-feed opening in the take-up reel housing;
e. a take-up reel removably and rotatably mounted within the take-up reel housing;
f. a first locking mechanism to prevent movement of the take-up reel; and
g. a first wind-up means on the take-up reel for winding a dispensed length of material on the take-up reel;
wherein the supply reel housing and the take-up reel housing are removably coupled to each other and when coupled together, the supply reel housing covers the in-feed opening and the take-up reel housing covers the out-feed opening.

7. The system according to claim 6, wherein the supply reel housing comprises an upper portion and a lower portion.

8. The system according to claim 7, wherein the upper portion of the supply reel housing is coupled to the lower portion of the supply reel housing by a living hinge.

9. The system according to claim 6, wherein the take-up reel housing comprises an upper portion and a lower portion.

10. The system according to claim 9, wherein the upper portion of the take-up reel housing is coupled to the lower portion of the take-up reel housing by a living hinge.

11. The system according to claim 6, further comprising a supply reel removably and rotatably mounted within the supply reel housing.

12. The system according to claim 6, further comprising one or more supply reel supports located within the supply reel housing.

13. The system according to claim 12, further comprising a supply reel removably and rotatably coupled to the one or more supply reel supports.

14. The system according to claim 13, further comprising a supply of material coupled to the supply reel.

15. The system according to claim 13, further comprising a second locking mechanism to prevent movement of the supply reel.

16. The system according to claim 6, wherein the supply reel housing comprises at least one male connector and the take-up reel housing comprises at least one female connector.

17. The system according to claim 16, wherein the at least one male connector is coupled to the at least one female connector.

18. The system according to claim 14, wherein the supply of material comprises dental floss.

19. A method of using the system according to claim 1, the method comprising the steps of:
a) separating the upper portion of the supply reel housing from the lower portion of the supply reel housing;
b) separating the upper portion of the take-up reel housing from the lower portion of the take-up reel housing;
c) placing the supply reel into the supply reel housing;
d) placing the take-up reel into the take-up reel housing;
e) dispensing the supply of material out of the supply reel housing through the out-feed opening and into the take-up reel housing through the in-feed opening;
f) inserting the supply of material into the slot located on the take-up reel;
g) winding the take-up reel using the first wind-up means to secure the supply of material to the take-up reel;
h) coupling the upper portion of the supply reel housing to the lower portion of the supply reel housing;
i) coupling the upper portion of the take-up reel housing to the lower portion of the take-up reel housing; and
j) flossing a user's teeth with the dispensed supply of material.

20. The method of claim 19, wherein the supply of material comprises dental floss.
